(19) United States
(12) Patent Application Publication
(10) Pub. No.: US 2015/0354734 A1
(43) Pub. Date: Dec. 10, 2015

(54) SWEAT SOLDER RETAINER

(71) Applicant: US Industrial Sourcing, L.L.C, Garland, TX (US)

(72) Inventor: Tommy Jefferson Jones, III, Wylie, TX (US)

(21) Appl. No.: 14/716,105

(22) Filed: May 19, 2015

Related U.S. Application Data
(60) Provisional application No. 62/007,839, filed on Jun. 4, 2014.

(51) Int. Cl. F16L 13/08; F16L 21/00; F16L 15/08

(52) U.S. Cl. CPC F16L 13/08; F16L 15/08; F16L 21/00

(57) ABSTRACT

An apparatus and method are described for coupling a pipe to a plumbing element, such as a valve. The apparatus includes a threaded section adjacent to a first opening and a coupling section adjacent to a second opening. An internal surface of the coupling section is configured to couple to an external surface of a pipe. The apparatus also includes a clamping section located between the threaded section and the coupling section for applying a rotational force to the apparatus. The clamping section includes an internal support ridge and an internal valley to reduce heat transfer between the coupling section and the threaded section.

### CROSS-REFERENCE TO RELATED APPLICATIONS

Pursuant to 35 U.S.C. §119(e), this application claims priority from, and hereby incorporates by reference for all purposes, U.S. Provisional Patent Application Ser. No. 62/007,839, entitled “Sweat Solder Retainer,” filed Jun. 4, 2014 and naming Tommy Jefferson Jones III as an inventor.

### TECHNICAL FIELD

This disclosure relates to a connector for coupling a copper pipe to another pipeline element, such as a valve. In particular, this disclosure relates to a sweat solder retainer that includes a thermal diffusion section and an overall design to reduce the amount of heat, as well as the amount of time the heat must be applied, to solder the retainer to a pipe.

### BACKGROUND OF THE DISCLOSURE

Soldering copper tubing to a valve or other pipeline element is a common process in the plumbing and construction industries. Often, a connector or retainer is placed between the copper tubing and the pipeline element to secure the copper tubing to the pipeline element. While various connectors or retainers are used, the connector or retainer typically includes a threaded section for coupling to the pipeline element and a cylindrical section for coupling to the copper tubing.

In the sweat soldering process, the copper tubing is cleaned and sanded, if necessary, to provide a clean surface to attach the connector or retainer. The end of the copper tubing is inserted within the cylindrical section of the retainer and heat is applied to the surface of the retainer by a propane torch or other heat source at between about 350-550° F. A solid flux or solder is applied to the intersection of the copper tubing and the cylindrical section of the retainer as the heat is applied to melt the solder. The solder is then drawn into the area between the external surface of the copper tubing and the internal surface of the cylindrical section. The solder, the copper pipe and the retainer are then allowed to cool and the solder solidifies to couple the copper pipe to the retainer.

During the heating process, heat transfers from the heat source to the retainer, the copper tubing and any elements that are attached or thermally linked to the retainer or the copper tubing. Excessive high temperatures or long durations of heating can damage the retainer, the copper tubing or other elements that are thermally linked with the retainer or the copper tubing, such as valves. What is needed is a retainer that is configured to reduce the amount of heat required to melt the solder and that is configured to reduce the amount of time that heat must be applied to melt the solder, thereby reducing possible heat damage to the tubing, the retainer or any other parts that are thermally linked to the tubing or the retainer.

### SUMMARY

In a first aspect, there is described an apparatus for coupling a pipe to a plumbing element. The apparatus includes a threaded section adjacent to a first opening and a coupling section adjacent to a second opening, wherein an internal surface of the coupling section is configured to couple to an external surface of a pipe. The apparatus also includes a clamping section located between the threaded section and the coupling section for applying a rotational force to the apparatus, wherein the clamping section includes an internal support ridge and an internal valley to reduce heat transfer between the coupling section and the threaded section.

In some embodiments, the clamping section includes an external surface feature for applying a rotational force to the apparatus.

In some embodiments, the external surface feature is in the shape of a polygon.

In some other embodiments, the external surface feature is in the shape of a hexagon.

In other embodiments, the internal valley has a first sidewall thickness and the internal support ridge has a second sidewall thickness, wherein the first sidewall thickness is thinner than the second sidewall thickness.

In some other embodiments, the internal ridge includes a tapered section to provide structural support to the clamping section.

In a second aspect, there is described a method of sweat soldering a pipe to a retainer that includes providing a retainer that includes a threaded section adjacent to a first opening, a coupling section adjacent to a second opening and a clamping section located between the threaded section and the coupling section. The method includes placing a portion of a pipe within the coupling section and heating the coupling section and applying liquefiable binder to an intersection between the coupling section and the portion of the pipe. The method also includes restraining heat transfer from the coupling section to the threaded section by an internal valley of the retainer.

In some embodiments, restraining heat transfer from the coupling section to the threaded section comprises providing an internal valley in the clamping section.

In some other embodiments, the internal valley includes a thinner sidewall than sidewalls of a first internal ridge and a second internal ridge adjacent to the internal valley.

In a third aspect, there is described an apparatus for coupling to a pipe by sweat soldering that includes a threaded section, a coupling section and a clamping section located between the threaded section and the coupling section. The clamping section comprises an external surface feature for applying a rotational force to the apparatus and a first internal ridge, a second internal ridge and an internal valley located between the first internal ridge and the second internal ridge to reduce heat transfer from the coupling section to the threaded section.

In some embodiments, the first and second internal ridges provide structural support for the clamping section.

In some other embodiments, the external surface feature of the clamping section is a hexagon.

Other aspects, features, and advantages will become apparent from the following detailed description when taken in conjunction with the accompanying drawings, which are a part of this disclosure and which illustrate, by way of example, principles of the inventions disclosed.

### DESCRIPTION OF THE FIGURES

The accompanying drawings facilitate an understanding of the various embodiments.

FIG. 1 is a perspective view of a valve coupled to a copper pipe by way of a retainer in accordance with this disclosure.

FIG. 2 is a cutaway side view of a prior art retainer that includes a thick clamping section.

FIG. 3 is a cutaway side view of another prior art retainer that includes a thick clamping section.

FIG. 4. is a cutaway side view of an embodiment of an improved retainer in accordance with this disclosure.

FIG. 5 is a cutaway perspective view of an embodiment of an improved retainer in accordance with this disclosure.

FIG. 6 is a top view of an embodiment of an improved retainer in accordance with this disclosure.

FIG. 7 is a schematic block diagram illustrating an embodiment of a method of seat soldering a pipe to a retainer in accordance with this disclosure.

### DETAILED DESCRIPTION

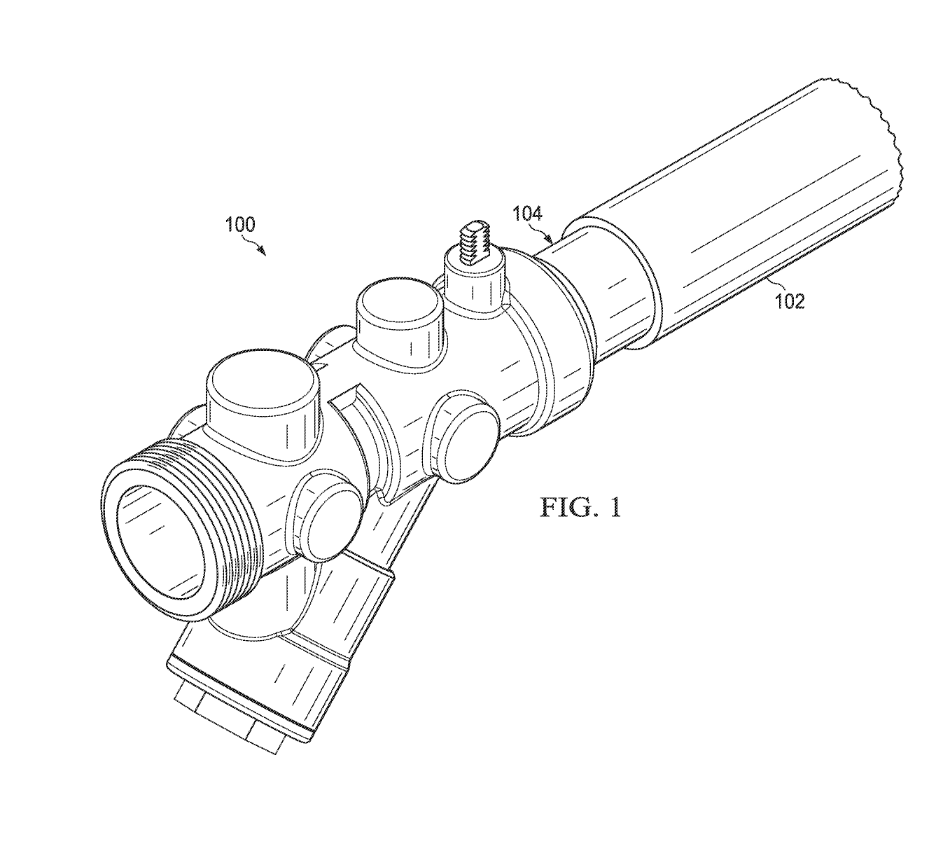

FIG. 1 is a perspective view of a valve 100 coupled to a copper pipe 102 by way of a retainer 104. As described above, copper pipe 102 is often coupled to other piping or pipeline equipment, such as a valve 100, by way of a retainer 104 that is soldered to the copper pipe 102. In some instances, the retainer 104 is coupled to the pipe 102 in a process known as “sweat soldering.” In the sweat soldering process, heat is applied to the retainer 104 while a solid flux or solder material is placed at the intersection between the retainer 104 and the copper pipe 102. As the retainer material is heated, the solder material melts and flows between an internal surface of the retainer 104 and an external surface of the pipe 102. Once a sufficient amount of solder material has migrated to the area between the retainer 104 and the pipe 102, the heat is removed from the retainer 104. The solder, the retainer 104 and the pipe 102 are then allowed to cool and the solder solidifies to form a rigid connection between the retainer 104 and the pipe 102.

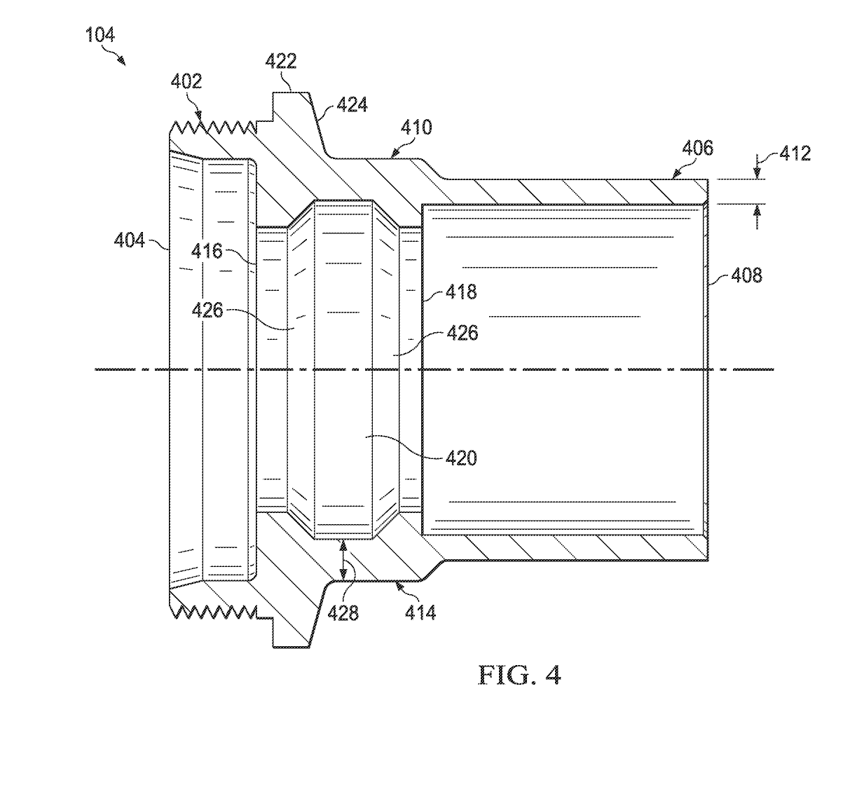

It has been found, however, that excessive heating of a retainer and/or prolonged application of heat to the retainer can damage the retainer, the copper pipe and/or the piping equipment coupled to the retainer, such as, for example, a valve coupled to the retainer. As will be described in more detail below, the improved retainer 104 of the present disclosure has a lower mass in a heat diffusing area or clamping section 410 (FIG. 4) to reduce the amount of material that must be heated to melt the flux and to reduce the amount of time needed to melt the flux. The improve retainer 104 also includes structural supports for a reduced-size clamping section 410 (FIG. 4) to allow for proper clamping for applying rotational force to the retainer 104. The improve retainer 104 also includes an elongated coupling section 406 (FIG. 4) to provide a distance between an area of the retainer 104 to which heat is applied and an area of the retainer 104 that is coupled to a valve 100 or other piping equipment. As will be described in more detail below, the clamping section 410 includes a reduced thickness 428 and an internal valley 420 to reduce the heat flow from the coupling section 406 to the threaded section 402 when the coupling section 406 is heated.

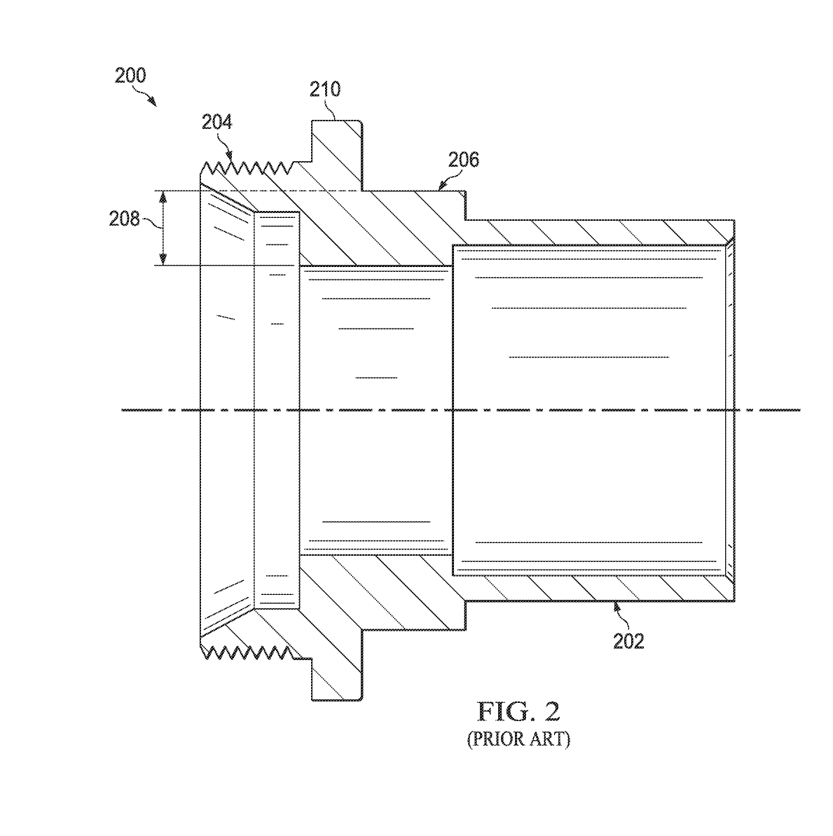

Referring now to FIG. 2, a cutaway side view of a prior art retainer 200 is shown that includes a cylindrical section 202, a threaded end 204 and a hexagonal section 206 located between the cylindrical section 202 and the threaded end 204. As will be described in more detail below, the hexagonal section 206 includes a large wall thickness 208 which increases an amount of heat transferred from the cylindrical section 202 to the threaded end 204 when the cylindrical section 202 is heated to melt the flux. The increased wall thickness 208 of the hexagonal section 206 also increases the amount of material that must be heated, and, thus, the amount of time that the retainer 200 must be heated and/or the amount of heat that must be applied to the retainer 200, in order to melt the solder. The increased wall thickness 208 also increases the amount of time required for the retainer 200 to cool to ambient temperatures after being heated. In addition, the hexagonal section 206 of the retainer 200 is directly adjacent to a flange 210 and the threaded end 204, thus increasing the heat transferred from the cylindrical section 202 to the threaded end 204 when the cylindrical section 202 is heated.

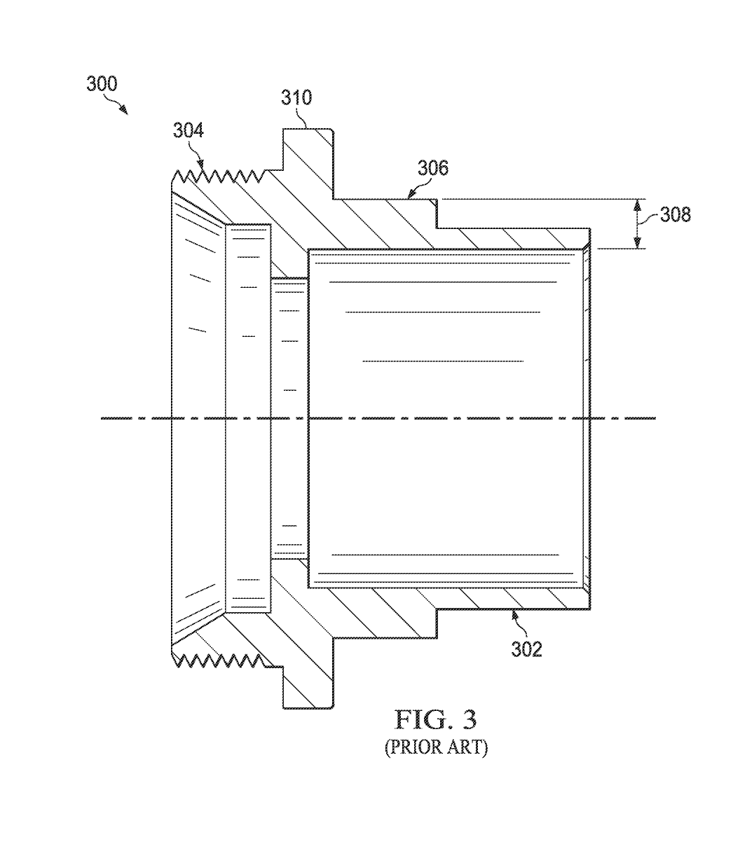

Referring now to FIG. 3, a cutaway side view of another prior art retainer 300 is shown that includes a cylindrical section 302, a threaded end 304 and a hexagonal section 306. As discussed above, the hexagonal section 306 includes a large wall thickness 308 which increases the amount of heat transferred from the cylindrical section 302 to the threaded end 304 when the cylindrical section 302 is heated and also increases the amount of time required to heat, and then subsequently cool, the retainer 30. In addition, as described above, the hexagonal section 306 is directly adjacent to a flange 310 and the threaded end 304, thus increasing the heat transfer from the cylindrical section 32 to the threaded end 304 when the cylindrical section 302 is heated.

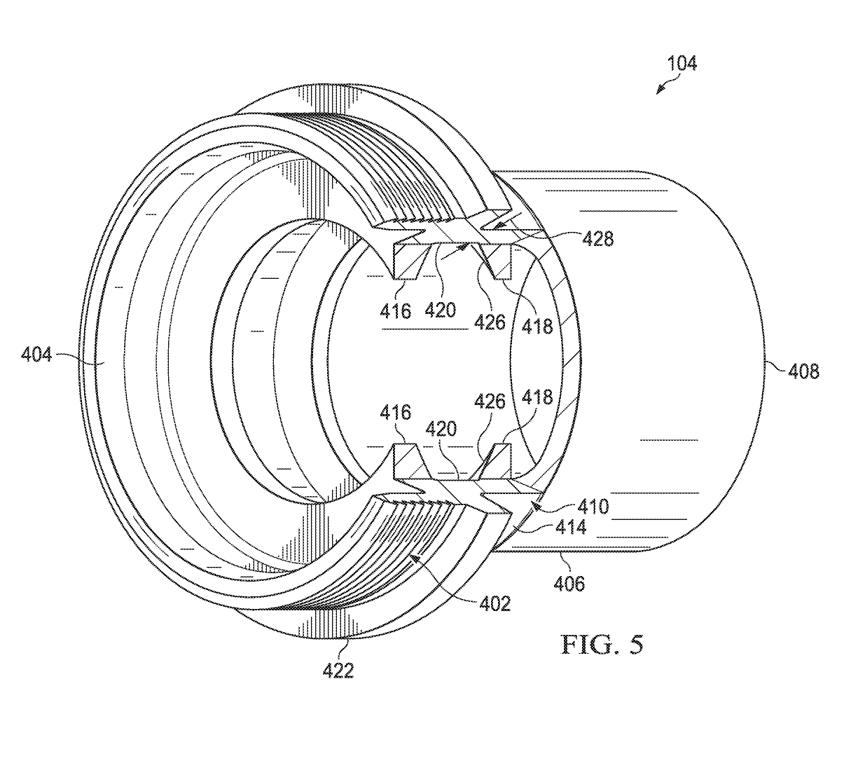

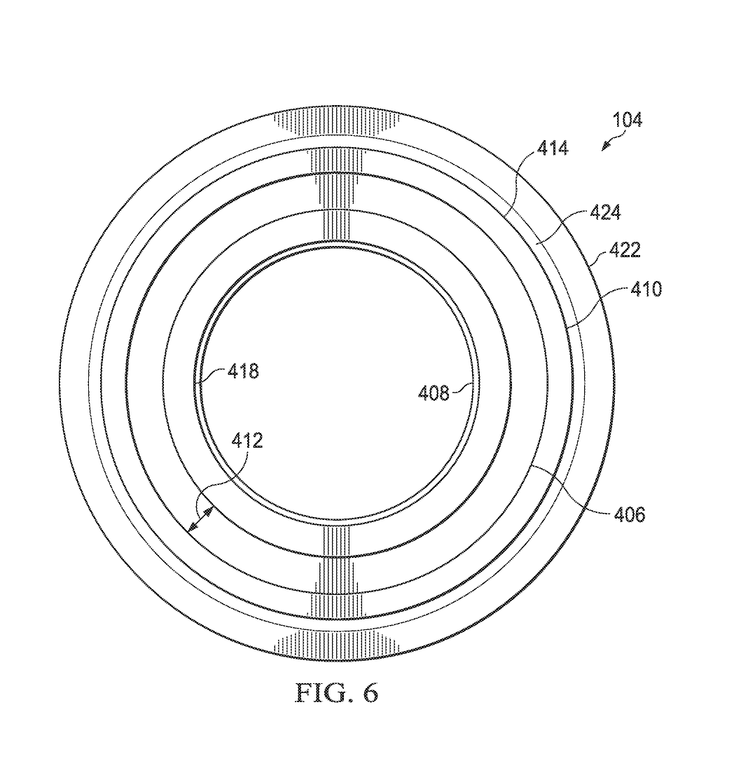

Referring now to FIGS. 4-6, the improved retainer 104 of FIG. 1 is shown in greater detail. The improved retainer 104 includes a threaded section 402 adjacent to a first opening 404, a coupling section 406 adjacent to a second opening 408, and a clamping section 410 located between the threaded section 402 and the coupling section 406. The coupling section 406 is elongated and includes a reduced sidewall thickness 412 to decrease the mass of material that must be heated in the coupling section 406 to melt the solder. In some embodiments, the decreased mass of the coupling section 406 reduces the amount of time required to heat the coupling section and reduces the amount of heat that travels through the coupling section 406 to the clamping section 410. In addition, in some embodiments, the decreased mass of the coupling section 406 reduces the amount of time necessary to cool the retainer 104 after sweat soldering. The elongated shape of the coupling section 406 also increases a distance between a portion of the retainer 104 to which heat is applied (i.e., an end portion of the coupling section 406 near the second opening 408) and the threaded section 402. Thus, the amount of heat transferred through the retainer 104 from the coupling section 406 to the threaded section 402 is reduced.

The clamping section 410 includes an external surface feature 414, a first internal ridge 416, a second internal ridge 418 and an internal valley 420. The external surface feature 414 may be any suitable feature to allow a user to apply a rotational force to the retainer 104 to thread the retainer 104 to a pipeline element, such as the valve 100. For example, in some embodiments, the external surface feature 414 is a polygonal surface structure. In some embodiments, the polygonal surface structure is in the shape of a hexagon. In some embodiments, the clamping section 410 also includes a flange 422 between the external surface feature 414 and the threaded section 402 to provide a stopping point when the retainer 104 is threaded to a pipeline element and to provide structural support for the retainer 104. The flange 422 may include a tapered section 424 to further increase the structural strength of the retainer 104.

The clamping section 410 also includes a first internal ridge 416 and a second internal ridge 418 to provide structural support to the clamping section 410. In some embodiments, for example, the user may apply a wrench or other clamping tool to the external surface feature 414 to apply rotational force to the retainer 104. As such, the retainer 104 must have sufficient structural support to withstand the force that is applied to the external surface feature 414. In some embodiments, the first internal ridge 416 and the second internal ridge 418 provide structural support at the clamping section 410 to withstand forces applied by a user to the external surface feature 414. The first internal ridge 416 and the second internal ridge 418 may include tapered edges 426 to further strengthen the clamping section 410.

The clamping section 410 also includes an internal valley 420 located between the first internal ridge 416 and the second internal ridge 418. The internal valley 420 defines an area of the clamping section 410 with a decreased wall thickness 428. The decreased wall thickness 428 of the internal valley 420 reduces the mass of material in the clamping section 410 and, thus, reduces the rate and amount of heat transferred between the coupling section 406 and the threaded section 402 when the coupling section 406 is heated, and also reduces the amount of time needed to heat and cool the retainer 104. Thus, in some embodiments, the internal valley 420 reduces the amount of heat that diffuses through the retainer 104 per unit time and protects objects that may be coupled to the retainer 104, such as a valve 100 or other piping equipment. Although the first internal ridge 416, the second internal ridge 418 and the internal valley 420 are shown as angular elements, other configurations, such as configurations with rounded edges, are within the scope of this disclosure. In some embodiments, the internal valley 420 is referred to as a heat diffuser, a heat dam or a thermal break.

In some embodiments, the reduced wall thickness 428 of the clamping section 410 is designed to reduce the overall mass of the retainer 104 between the coupling section 406 and the threaded section 402. By reducing the mass in the clamping section 410, less heat can travel through the clamping section 410 by conduction per unit time. Thus, heat that is applied to the coupling section 406 during a sweat soldering operation diffuses more slowly through the clamping section 410 that in prior retainer designs. Hence, less heat reaches the threaded section 402 (and any piping elements coupled to the threaded section 402) in a typical sweat soldering operation. In other words, the thermal flow rate through the clamping section 410 is reduced due to the reduction of mass available to transfer heat by conduction. As such, the reduced thickness 428 of the clamping section 410 acts as a thermal barrier or diffuser to limit the rate of heat transfer from the coupling section 406 to the threaded section 402.

As a result of the reduced rate of heat transfer through the clamping section 410, more heat is also retained by the coupling section 406 in a typical sweat soldering operation. The retained heat, which would otherwise have been transferred to the threaded section 402 in prior designs, allows for more rapid heating of the coupling section 406 without overheating the threaded section 402.

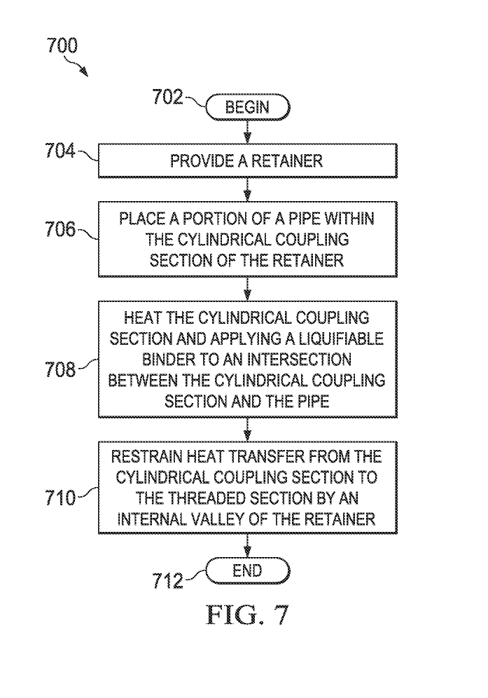

FIG. 7 illustrates an embodiment of a method 700 of sweat soldering a pipe 102 to a retainer 104. The method begins, as shown at block 702, and a retainer 104 is provided, as shown at block 704. As discussed above, the retainer 104 includes a threaded section 402 adjacent to a first opening 404 and a coupling section 406 adjacent to a second opening 408. The retainer 104 also includes a clamping section 410 located between the threaded section 402 and the coupling section 406.

As shown at block 706, a portion of the pipe 102 is placed within the coupling section 406 of the retainer 104. Heat is then applied to the coupling section 406 and a liquefiable binder, such as a solder material, is applied at an intersection between the coupling section 406 and the pipe 102. When the coupling section 406 reaches a temperature sufficient to melt the solder, the solder liquefies and flows between an internal surface of the coupling section 406 and an external surface of the pipe 102. At least a portion of the heat that has been applied to the coupling section 406 is restrained from transferring to the threaded section 402 by an internal valley 420 of the retainer, as shown at block 710. The method 700 then ends as shown at block 712.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

In addition, the foregoing describes only some embodiments of the invention(s), and alterations, modifications, additions and/or changes can be made thereto without departing from the scope and spirit of the disclosed embodiments, the embodiments being illustrative and not restrictive.

Furthermore, invention(s) have been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention(s). Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

What is claimed is:

1. An apparatus for coupling a pipe to a plumbing element, comprising:
a threaded section adjacent to a first opening and a coupling section adjacent to a second opening, wherein an internal surface of the coupling section is configured to couple to an external surface of a pipe; and
a clamping section located between the threaded section and the coupling section for applying a rotational force to the apparatus, wherein the clamping section comprises an internal support ridge and an internal valley to reduce heat transfer between the coupling section and the threaded section.

2. The apparatus of claim 1, wherein the clamping section comprises an external surface feature for applying a rotational force to the apparatus.

3. The apparatus of claim 2, wherein the external surface feature is in the shape of a polygon.

4. The apparatus of claim 3, wherein the external surface feature is in the shape of a hexagon.

5. The apparatus of claim 1, wherein the internal valley comprises a first sidewall thickness and the internal support ridge comprises a second sidewall thickness, wherein the first sidewall thickness is thinner than the second sidewall thickness.

6. The apparatus of claim 1, wherein the internal ridge includes a tapered section to provide structural support to the clamping section.

7. A method of sweat soldering a pipe to a retainer, comprising:
providing a retainer that comprises:
a first opening and a second opening;
a threaded section adjacent to the first opening;
a coupling section adjacent to the second opening; and
a clamping section located between the threaded section and the coupling section;
placing a portion of a pipe within the coupling section;
heating the coupling section and applying liquefiable binder to an intersection between the coupling section and the portion of the pipe; and
restraining heat transfer from the coupling section to the threaded section by an internal valley of the retainer.

8. The method of claim 7, wherein restraining heat transfer from the coupling section to the threaded section comprises providing an internal valley in the clamping section.

9. The method of claim 8, wherein the internal valley comprises a thinner sidewall than sidewalls of a first internal ridge and a second internal ridge adjacent to the internal valley.

10. An apparatus for coupling to a pipe by sweat soldering, comprising:
a threaded section and a coupling section;
a clamping section located between the threaded section and the coupling section, wherein the clamping section comprises an external surface feature for applying a rotational force to the apparatus and a first internal ridge, a second internal ridge and an internal valley located between the first internal ridge and the second internal ridge to reduce heat transfer from the coupling section to the threaded section.

11. The apparatus of claim 10, wherein first and second internal ridges provide structural support for the clamping section.

12. The apparatus of claim 10, wherein the external surface feature of the clamping section is a hexagon.
